(19) United States
(12) Patent Application Publication
(10) Pub. No.: US 2024/0330768 A1
(43) Pub. Date: Oct. 3, 2024

(54) SYSTEMS AND METHODS FOR CONTINUOUS MODEL TRAINING ON A PEER-TO-PEER NETWORK

(71) Applicant: JPMORGAN CHASE BANK, N.A., New York, NY (US)

(72) Inventors: Sudhir UPADHYAY, Edison, NJ (US); Suresh SHETTY, Mangalore (IN); Umar FAROOQ, New York, NY (US); Abbas ALI, London (GB); Palka PATEL, West Hartford, CT (US); Sushil RAJA, Manhattan, NY (US); Adam PATEL, London (GB)

(21) Appl. No.: 18/615,830

(22) Filed: Mar. 25, 2024

(30) Foreign Application Priority Data
Mar. 28, 2023 (IN) 202311022691

(51) Int. Cl. G06N 20/00; H04L 9/00

(52) U.S. Cl. CPC G06N 20/00; H04L 9/50

(57) ABSTRACT

In some aspects, the techniques described herein relate to a method including: providing, on a peer-to-peer distributed network, an aggregation server; implementing, at a first node of the peer-to-peer distributed network, a machine learning (ML) model, wherein the ML model is trained on a first private data set; sending the ML model to the aggregation server; replicating the ML model to a second node of the peer-to-peer distributed network, wherein the ML model is retrained on a second private data set to generate a retrained model; sending the retrained model to the aggregation server; aggregating the ML model and the retrained model to generate an aggregated model; and replicating the aggregated model to the first node of the peer-to-peer distributed network, wherein the ML model is promoted to a production model at the first node of the peer-to-peer distributed network.

### RELATED APPLICATIONS

This application claims priority to Indian provisional patent application serial number IN 202311022691 filed Mar. 28, 2023, the entirety of which is incorporated by reference herein.

### BACKGROUND

### 1. Field of the Disclosure

Embodiments generally relate to systems and methods for continuous model training on a peer-to-peer network.

### 2. Description of the Related Art

Payment product issuing organizations evaluate and measure the risk of a specific payment transaction by identifying potential anomalies in transactions based on historical data or by validating it against a set of well-known rules. Conventionally, such anomalies are detected by highly trained machine learning models trained over the organization's payment transaction data. The training of such models is conducted via proprietary methods, algorithms, and parameters that classify a transaction as potential fraud. In most cases, however, the efficacy of those models in predicting the fraud is only as good as the size and diversity of the underlying training data. Accordingly, to continuously improve model prediction performance, issuing organizations could collate their transaction data in one repository and leverage that repository to produce highly accurate models. Such a data repository, however, would not only be impractical from an operational standpoint, but may also violate both organizational safeguards and privacy laws.

### SUMMARY

Systems and methods for continuous model training on a peer-to-peer network are disclosed. According to an embodiment, a method may include: (1) training, at a first node of a peer-to-peer distributed network, a first version of a machine learning model on a first private data set; (2) sending, by the first node, the first version of the machine learning model to an aggregation server provided in the peer-to-peer distributed network; (3) replicating, by the first node, the first version of the first version of the machine learning model on a second node of the peer-to-peer distributed network; (4) training, by the second node, the machine learning model on a second private data set, resulting in a second version of the machine learning model; (5) sending, by the second node, the second version of the machine learning model to the aggregation server; (6) aggregating, by the aggregation server, the first version of the machine learning model and the second version of the machine learning model resulting in an aggregated machine learning model; and (7) sending, by the aggregation server, the aggregated machine learning model to the first node.

In one embodiment, the first version may be a genesis version of the machine learning model.

In one embodiment, the method may also include: replicating, by the first node or the second node, the first version of the machine learning model or the second version of the machine learning model on a third node in the peer-to-peer distributed network; training, by the third node, the first version of the machine learning model or the second version of the machine learning model using a third private data set, resulting in a third version of the machine learning model; and sending, by the third node, the third version of the machine learning model to the aggregation server. The aggregated machine learning model may include an aggregation of the first version of the machine learning model, the second version of the machine learning model, and the third version of the machine learning model, and the aggregation server further replicates the aggregated machine learning model on the third node.

In one embodiment, the first node sends weights for the first version of the machine learning model to the aggregation server.

In one embodiment, the second node sends weights for the second version of the machine learning model to the aggregation server.

In one embodiment, the aggregation server sends weights for the aggregated machine learning model to the first node and the second node.

In one embodiment, the peer-to-peer distributed network may be a permissioned blockchain network.

In one embodiment, the method may also include: incorporating, by the first node, the aggregated machine learning model into the first version of the machine learning model; training, by the first node, the first version of the machine learning model with an additional first private dataset, resulting in an updated first version of the aggregated machine learning model; sending, by the first node, the updated first version of the aggregated machine learning model to the aggregation server; incorporating, by the second node, the aggregated machine learning model into the second version of the machine learning model; training, by the second node, the aggregated machine learning model with an additional second private dataset, resulting in an updated second version of the aggregated machine learning model; sending, by the second node, the updated second version of the aggregated machine learning model to the aggregation server; aggregating, by the aggregation server, the updated first version of the aggregated machine learning model and the updated second version of the aggregated machine learning model, resulting in a second aggregated machine learning model; and sending, by the aggregation server, the second aggregated machine learning model to the first node and the second node.

In one embodiment, the first node trains the first version of the machine learning model until a desired accuracy is reached. In one embodiment, the method may also include: incorporating, by the first node, the aggregated machine learning model into the first version of the machine learning model; and deploying, by the first node, the first version of the machine learning model for inference generation to a production environment for an implementing organization, wherein the implementing organization may be a participant of the peer-to-peer distributed network.

According to another embodiment, a system may include: a peer-to-peer distributed network comprising: a first node; a second node; and an aggregation server. The first node may be configured to train a first version of a machine learning model on a first private data set, to send the first version of the machine learning model to the aggregation server, and to replicate the first version of the first version of the machine learning model on the second node. The second may be configured to train the machine learning model on a second private data set, resulting in a second version of the machine learning node and to send the second version of the machine learning model to the aggregation server. The aggregation server may be configured to aggregate the first version of the machine learning model and the second version of the machine learning model resulting in an aggregated machine learning model and to send the aggregated machine learning model to the first node.

In one embodiment, the first version may be a genesis version of the machine learning model.

In one embodiment, the peer-to-peer distributed network further may include a third node, and the first node may be configured to replicate the first version of the machine learning model on the third node, or the second node may be configured to replicate the second version of the machine learning model on the third node; the third node may be configured to train the first version of the machine learning model or the second version of the machine learning model using a third private data set, resulting in a third version of the machine learning model; and the third node may be configured to send the third version of the machine learning model to the aggregation server. The aggregated machine learning model may include an aggregation of the first version of the machine learning model, the second version of the machine learning model, and the third version of the machine learning model, and the aggregation server may be configured to send the aggregated machine learning model to the third node.

In one embodiment, the first node may be configured to send weights for the first version of the machine learning model to the aggregation server, the second node may be configured to send weights for the second version of the machine learning model to the aggregation server, add the aggregation server may be configured to send weights for the aggregated machine learning model to the first node and the second node.

In one embodiment, the peer-to-peer distributed network may be a permissioned blockchain network.

In one embodiment, the first node may be configured to incorporate the aggregated machine learning model into the first version of the machine learning model; the first node may be configured to train the first version of the machine learning model with an additional first private dataset, resulting in an updated first version of the aggregated machine learning model; the first node may be configured to send the updated first version of the aggregated machine learning model to the aggregation server; the second node may be configured to incorporate the aggregated machine learning model into the second version of the machine learning model; the second node may be configured to train|the aggregated model with an additional second private dataset, resulting in an updated second version of the aggregated machine learning model; the second node may be configured to send the updated second version of the aggregated machine learning model to the aggregation server; the aggregation server may be configured to aggregate the updated first version of the aggregated machine learning model and the updated second version of the aggregated machine learning model, resulting in a second aggregated model; and the aggregation server may be configured to send the second aggregated model to the first node and the second node.

In one embodiment, the first node may be configured to train the first version of the machine learning model until a desired accuracy is reached.

In one embodiment, the first node may be configured to incorporate the aggregated machine learning model into the first version of the machine learning model; and the first node may be configured to deploy the first version of the machine learning model for inference generation to a production environment for an implementing organization, wherein the implementing organization may be a participant of the peer-to-peer distributed network.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of a system for continuous model training on a peer-to-peer network, in accordance with aspects.

FIG. 2 illustrates a block diagram of a system for local model training, in accordance with aspects.

FIG. 3 is a logical flow for continuous model training using private data sets, in accordance with aspects.

FIG. 4 is a block diagram of a technology infrastructure and computing device for implementing certain aspects of the present disclosure, in accordance with aspects.

### DETAILED DESCRIPTION

Systems and methods for continuous model training on a peer-to-peer network are disclosed.

Embodiments may include systems and methods for calculation of anomaly metrics, such as payment fraud with respect to payment transactions, by securely aggregating risk insights from multiple organizations. In embodiments, participating organizations may participate without revealing the underlying data on which models are trained and calculations are made.

Embodiments described herein may provide a consistent way to train and utilize machine learning (ML) models on a peer-to-peer (P2P) network, such as a distributed ledger (DL) network. Exemplary aspects include models that identify fraud in payment transactions. While aspects are described in the context of fraud-identifying methods, the federated model learning/training techniques described herein may be applied to other models.

Embodiments may leverage existing channels on the P2P network to distribute a model to participants. Embodiments may further leverage privacy enhancing technologies (PET), such as federated learning frameworks, to exchange model weights and aggregate model results.

In embodiments, a consortium trusted and validated solution may be provided. Embodiments may provide a fair and transparent mechanism to reward network (e.g., model training) contributors commensurate with their contribution and may leverage model performance benchmarking that is consortium trusted. Additionally, a monetization scheme may allow non-contributing participants to benefit by paying a model fee (which fee may be fairly distributed among the contributing members).

Embodiments may include a peer-to-peer (P2P) network, such as a distributed ledger network, or may be built on a distributed ledger platform, such as a permissioned blockchain network. A P2P network may use a P2P protocol, such as a distributed ledger and/or blockchain protocol for communication between nodes. While a permissioned blockchain network is used as an exemplary network herein, any suitable P2P network protocol may be used to implement the techniques described herein.

In embodiments, a blockchain network may have multiple nodes, and each node may correspond to one of a plurality of participants on the network. For example, a four-node blockchain network may have four respective participants (i.e., four participating organizations) and each participant may be responsible for execution of their corresponding network node.

In embodiments, a first participant may train a local ML model with a local training dataset. The local training dataset may include historical data collected and housed by the first participant. Initial ML model training may be done in a backend technology infrastructure of the first participant.

Once the first participant has trained the model, the model may be implemented on the first participant's P2P network node.

A P2P network protocol, such as a blockchain protocol, may then replicate the model to each node on the blockchain network. That is, after replication, each participant will have a copy of the trained model implemented at its respective node. One or more smart contracts may be used to execute logic that replicates the model to the participating nodes. For example, the smart contracts may take the model parameters, the definitions, and the model weights from one node and replicate it to another node.

In one embodiment, the smart contacts may emit different events on the chain that other nodes subscribe to. Examples of events may include local training completed, a new global model available, aggregation of models from different nodes completed, etc. These events help other nodes in the chain to notify users in their realm about availability of new global models for them to revisit the results.

While each participant will be able to use the model for predictions, inferences, etc., the training data set of each participant will not be revealed to the other network participants. The initially trained model may also be replicated to an aggregation server that is in operative communication with the network nodes. In some embodiments, the aggregation server may be hosted on a network node.

After the model has replicated to each network node, each participant may expose their node-copy of the model to their own training data set and execute training functions to update the model's training to reflect the exposure to each participant's data. Each participant's training data may include historical data that is private to the respective participant. For example, a second network participant may train their copy of the model on their own private data (e.g., payment transaction data), a third participant may train its copy of the model on its own private data, and so on.

Once an individual participant has trained its local copy of the model, the model may be sent to an aggregation server. An aggregation server may be available to all participant nodes operating on the network. The aggregation server may receive the first version of the trained model (e.g., from the first participant, as described above). Thereafter, the aggregation server may receive, in turn, an updated version of the model from each participant node.

Each updated version of the model may be further trained on the corresponding participant's private training data set, as described above. As the aggregation server receives an updated model from a participant node, the aggregation server may aggregate the updated model with the latest model that is stored.

For example, an aggregation server may receive a first version of a model trained by a first participant of a blockchain network. The aggregation server may store the first version. The aggregation server may then receive a second version of the model. The second version of the model may be trained using a second participant's private training data set. The aggregation server may perform aggregation functions that aggregate the weights of the first version and the second version of the model. An example of an aggregation function includes the federated average algorithm that may perform an arithmetic average of model weights from different local models.

After aggregation, the aggregation server may replicate the aggregated model to each node of the network. Each participant may replace the existing version of the model executing at its node with the received aggregated version.

Moreover, a third participant may expose the aggregated version of the model to its private training data set, which additional training may adjust model weights based on the additional training. After the third participant has finished retraining the aggregated model, it may send the retrained version to the aggregation server, which may aggregate the stored version of the aggregated model and the newly received retrained version that has been trained on the third participant's private training dataset.

The above pattern may continue in perpetuity, with the aggregation server receiving models (re) trained on participants' private training datasets and aggregating the retrained model's features with the most recent version of the aggregated model stored at the aggregation server. After aggregation, the aggregation server may replicate the current version of the aggregated model to all participating nodes, e.g., using logic executed via a smart contract, and may store the current version of the model.

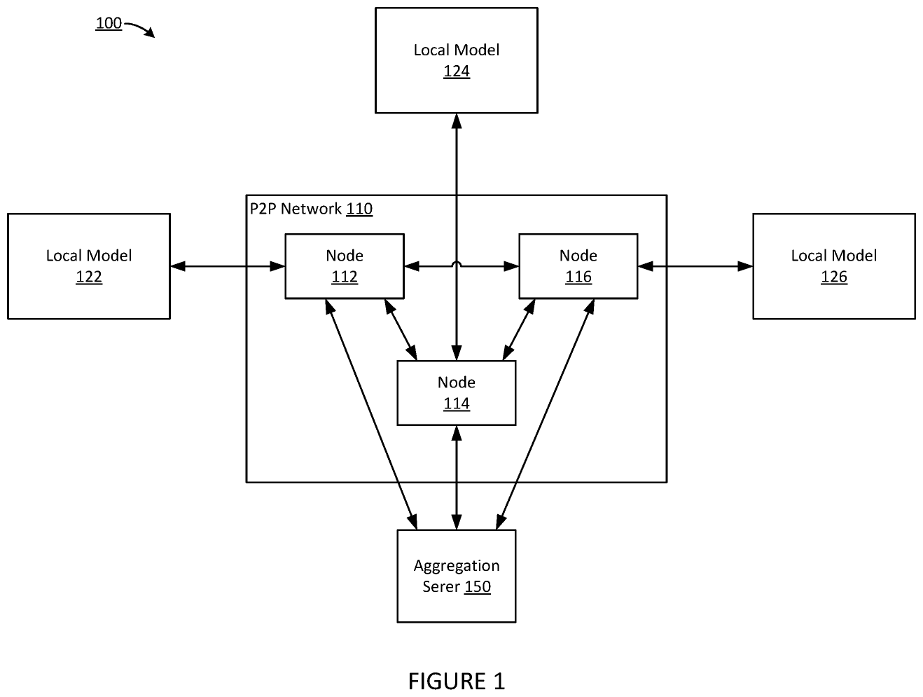

Referring to FIG. 1, a block diagram of a system for continuous model training on a peer-to-peer network is provided according to an embodiment. System 100 includes P2P network 110. P2P network 110 may be any suitable peer-to-peer network, such as a distributed ledger network, a permissioned blockchain network that operates on a distributed ledger network, etc. P2P network 110 may include node 112, node 114, and node 116. Each of node 112, node 114, and node 116 may be a node on P2P network 110. Each node may be in operative communication with the other nodes included in P2P network 110.

A node may include a physical server, a virtual server, or the like that executes a node service. A node service may be software such as an operating system and/or a computer program that facilitates operative communication with other nodes on P2P network 110 and that executes and provides protocols and other software that is required for node membership. For instance, a node service may be a blockchain service that facilitates data writes to blocks of the blockchain, replication between nodes, a consensus protocol, etc.

The node service may also include a computer program that may train its ML model and communicate with other nodes and aggregation server 150.

Node 112, node 114, and node 116 may each be hosted by a different implementing organization on the respective organizations' technology infrastructure. That is, each respective implementing organization may be a P2P network participant, as described herein. Thus, node 112, node 114, and node 116 may also be in operative communication with devices and services on an implementing organization's technology infrastructure, such as devices and services that facilitate training of a local ML model with a local training dataset, among other devices and services.

System 100 may also include local model 122, local model 124, and local model 126. Each of local model 122, local model 124, and local model 126 illustrates a model that is trained on the local technology infrastructure of an implementing organization that is a participant in P2P network 110. Each of local model 122, local model 124, and local model 126 may be trained on a local model training platform that is part of a local technology infrastructure of a participating implementing organization. For instance, local model 122 may be trained as described herein on a local model training platform and a copy of local model 122 that is trained with an organization's private data may then be sent to the participating organization's corresponding node (in the case of local model 122, this is node 112) and may be written to the node. If the node (e.g., node 112) is a member of a blockchain network, the model may be written to one or more blocks of the blockchain.

System 100 may also include aggregation server 150. Aggregation server 150 may be hosted as a node of P2P network 110, may be hosted by a participating organization, may be hosted by a third-party service provider, etc. Nodes of P2P network 110 may be configured to send copies of models stored at the node to aggregation server 150. Aggregation server 150 may be configured to receive copies of models stored at P2P network nodes and aggregate the model weights into a new version of a model.

For example, a copy of local model 122 that has been trained on local data may be sent to node 112. Node 112 may be configured to send the copy of local model 122 to aggregation server 150. Aggregation server 150 may aggregate the weights of the received model with a model stored at aggregation server 150. This aggregation process may create a new version of the model stored at aggregation server 150. Any given version of a model stored at aggregation server 150 may be referred to herein as an aggregated model.

Aggregation server 150 may send the newly created version of the aggregated model back to node 112. Node 112 may then send the copy of the newly created version of the aggregated model to the participating organization's technology infrastructure, where the model may be used for inference/predictions. The model may also be re-trained by the participating organization on new (e.g., more up to date) private data.

After a local retraining process, the model may have different weight configurations based on the most recent training with private organizational data. Thus, the copy of the aggregated model may be transformed back into a local model whose updated model weights have not yet been aggregated by aggregation server 150 into a most recent version of the aggregated model. Accordingly, a new version of local model 122 may be sent to node 112, node 112 may replicate the model to aggregation server 150, and the aggregation process, as described herein, may start over.

Upon receiving a new version of the aggregated model, P2P network nodes may replicate the new version to other nodes in the P2P network. Thus, each node in the P2P network may receive a copy of the most recent version of the aggregated model. When a local training process is to be undertaken, a P2P network node may send the most recent version of the aggregated model stored on the node to the node's corresponding private technology infrastructure, where the aggregated model will be trained on private local data to generate a new version of a local model that will be sent back to the corresponding P2P node. The node may then undertake the aggregation process with, for example, aggregation server 150.

The process of local training of a local model, sending the local model to a P2P node, the P2P node sending the copy of the local model to an aggregation server, and the aggregation server aggregating the model with an aggregated model, sending the aggregated model back to the P2P node, and the P2P node replicating the model to other P2P nodes may take place continuously. In this way, the aggregated model is continuously being updated with local training data from P2P network participants, but the local data remains private to the associated network participant while the benefits of model training on the local data are realized through the aggregation process.

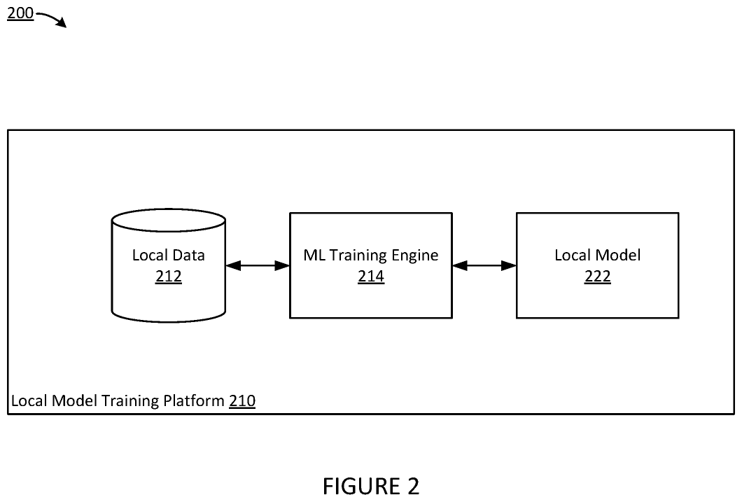

Referring to FIG. 2, a block diagram of a system for local model training is disclosed according to an embodiment. System 200 includes local model training platform 210, which includes local data 212, ML training engine 214, and local model 222. Local model training platform 210 may execute training of local models on an implementing organization's private technology infrastructure, as described herein. ML training engine 214 may use local data 212 (which may be stored in any suitable data store) to train local model 222. Local model training platform 210 may then send a copy of local model 222 to a corresponding node of a P2P network. Local model training platform 210 may also receive updated versions of an aggregated model and perform local training with local data 212 on the aggregated model, as described herein.

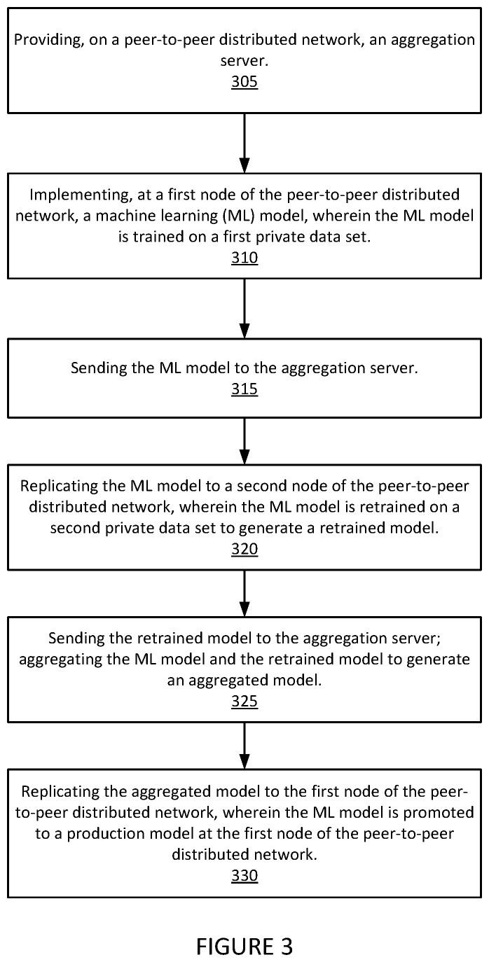

Referring to FIG. 3, a logical flow for continuous model training using private data sets is provided according to an embodiment.

In step 305, an aggregation server may be provided on a peer-to-peer network, such as a distributed ledger network.

In step 310, a first node of the peer-to-peer distributed network may implement a first version of a ML model that may be trained on a first private data set. The first private data set may be provided by an entity associated with the first node.

In step 315, the first node may send the first version (e.g., the initial or genesis version) of the ML model to the aggregation server. For example, the first node may send its model parameters, definitions, and/or model weights to the aggregation server.

In step 320, the first version of the ML model may be replicated on a second node of the peer-to-peer network. In one embodiment, a smart contact may replicate the first version of the ML model on the second node.

In step 325, the second node may train the first version of the ML model using a second private data set to generate a second version of the ML model. The second private data set may be provided by an entity associated with the second node.

In step 330, the second node may send the second version of the ML model to the aggregation server. For example, the second node may send its model parameters, definitions, and/or model weights to the aggregation server.

It should be noted that the first version of the ML model may be deployed to multiple nodes, and each node may train the ML model with its own private data set. The nodes may send their ML models to the aggregation server.

In step 335, the aggregation server may aggregate the first version of the ML model and the second version of the ML model (and any other versions of the ML model received from other nodes). For example, the aggregation server may use the federated average algorithm to aggregate the ML models.

In step 340, the aggregated model may be replicated on the first node. For example, the aggregation server may send the aggregated ML model's parameters, definitions, and/or weights to the first node.

In one embodiment, the aggregation server may also replicate the aggregated ML model on the second node, as well as any other nodes that may have provided their ML models.

In step 345, the first node may determine whether to continue to train the ML model. For example, if the ML model has reached a desired performance accuracy, the training may be complete, and, in step 350, the ML model may be deployed to a production environment.

If continued training is desired, the process may return to step 310 and the first node may continue to train the ML model with the first private data set, additional data sets received, etc.

If additional data sets are not received, the first node may receive updated aggregated model parameters from the aggregation server based on training performed by the other nodes.

In one embodiment, even once deployed to the production environment, the model may be retrained, updated, etc. as is necessary and/or desired.

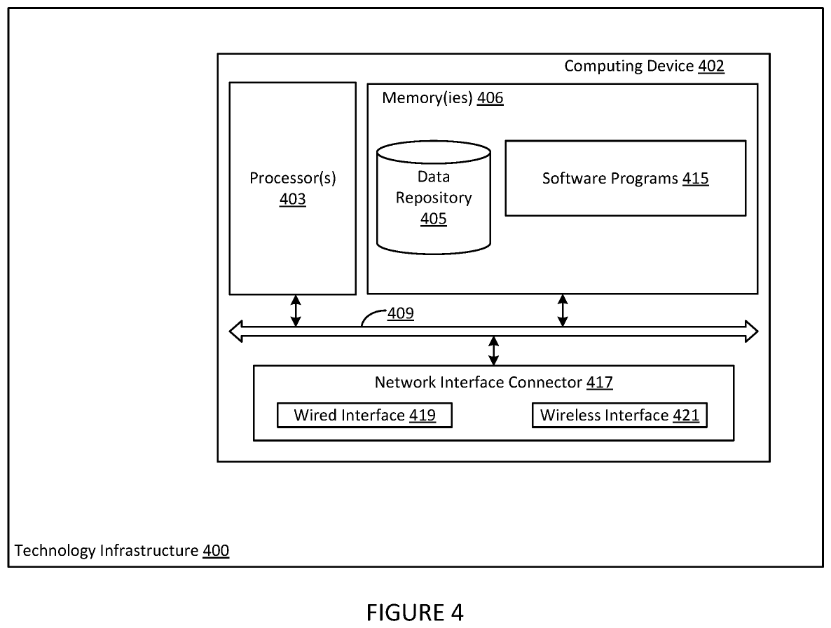

FIG. 4 is a block diagram of a technology infrastructure and computing device for implementing certain aspects of the present disclosure, in accordance with aspects. FIG. 4 includes technology infrastructure 400. Technology infrastructure 400 represents the technology infrastructure of an implementing organization. Technology infrastructure 400 may include hardware such as servers, client devices, and other computers or processing devices. Technology infrastructure 400 may include software (e.g., computer) applications that execute on computers and other processing devices. Technology infrastructure 400 may include computer network mediums, and computer networking hardware and software for providing operative communication between computers, processing devices, software applications, procedures and processes, and logical flows and steps, as described herein.

Exemplary hardware and software that may be implemented in combination where software (such as a computer application) executes on hardware. For instance, technology infrastructure 400 may include webservers, application servers, database servers and database engines, communication servers such as email servers and SMS servers, client devices, etc. The term “service” as used herein may include software that, when executed, receives client service requests and responds to client service requests with data and/or processing procedures. A software service may be a commercially available computer application or may be a custom-developed and/or proprietary computer application. A service may execute on a server. The term “server” may include hardware (e.g., a computer including a processor and a memory) that is configured to execute service software. A server may include an operating system optimized for executing services. A service may be a part of, included with, or tightly integrated with a server operating system. A server may include a network interface connection for interfacing with a computer network to facilitate operative communication between client devices and client software, and/or other servers and services that execute thereon.

Server hardware may be virtually allocated to a server operating system and/or service software through virtualization environments, such that the server operating system or service software shares hardware resources such as one or more processors, memories, system buses, network interfaces, or other physical hardware resources. A server operating system and/or service software may execute in virtualized hardware environments, such as virtualized operating system environments, application containers, or any other suitable method for hardware environment virtualization.

Technology infrastructure 400 may also include client devices. A client device may be a computer or other processing device including a processor and a memory that stores client computer software and is configured to execute client software. Client software is software configured for execution on a client device. Client software may be configured as a client of a service. For example, client software may make requests to one or more services for data and/or processing of data. Client software may receive data from, e.g., a service, and may execute additional processing, computations, or logical steps with the received data. Client software may be configured with a graphical user interface such that a user of a client device may interact with client computer software that executes thereon. An interface of client software may facilitate user interaction, such as data entry, data manipulation, etc., for a user of a client device.

A client device may be a mobile device, such as a smart phone, tablet computer, or laptop computer. A client device may also be a desktop computer, or any electronic device that is capable of storing and executing a computer application (e.g., a mobile application). A client device may include a network interface connector for interfacing with a public or private network and for operative communication with other devices, computers, servers, etc., on a public or private network.

Technology infrastructure 400 includes network routers, switches, and firewalls, which may comprise hardware, software, and/or firmware that facilitates transmission of data across a network medium. Routers, switches, and firewalls may include physical ports for accepting physical network medium (generally, a type of cable or wire—e.g., copper or fiber optic wire/cable) that forms a physical computer network. Routers, switches, and firewalls may also have “wireless” interfaces that facilitate data transmissions via radio waves. A computer network included in technology infrastructure 400 may include both wired and wireless components and interfaces and may interface with servers and other hardware via either wired or wireless communications. A computer network of technology infrastructure 400 may be a private network but may interface with a public network (such as the internet) to facilitate operative communication between computers executing on technology infrastructure 400 and computers executing outside of technology infrastructure 400.

FIG. 4 further depicts exemplary computing device 402. Computing device 402 depicts exemplary hardware that executes the logic that drives the various system components described herein. Servers and client devices may take the form of computing device 402. While shown as internal to technology infrastructure 400, computing device 402 may be external to technology infrastructure 400 and may be in operative communication with a computing device internal to technology infrastructure 400.

In accordance with aspects, system components such as a P2P network node, an aggregation server, a ML training engine, client devices, servers, various database engines and database services, and other computer applications and logic may include, and/or execute on, components and configurations the same, or similar to, computing device 402.

Computing device 402 includes a processor 403 coupled to a memory 406. Memory 406 may include volatile memory and/or persistent memory. The processor 403 executes computer-executable program code stored in memory 406, such as software programs 415. Software programs 415 may include one or more of the logical steps disclosed herein as a programmatic instruction, which can be executed by processor 403. Memory 406 may also include data repository 405, which may be nonvolatile memory for data persistence. The processor 403 and the memory 406 may be coupled by a bus 409. In some examples, the bus 409 may also be coupled to one or more network interface connectors 417, such as wired network interface 419, and/or wireless network interface 421. Computing device 402 may also have user interface components, such as a screen for displaying graphical user interfaces and receiving input from the user, a mouse, a keyboard and/or other input/output components (not shown).

In accordance with aspects, services, modules, engines, etc., described herein may provide one or more application programming interfaces (APIs) in order to facilitate communication with related/provided computer applications and/or among various public or partner technology infrastructures, data centers, or the like. APIs may publish various methods and expose the methods, e.g., via API gateways. A published API method may be called by an application that is authorized to access the published API method. API methods may take data as one or more parameters or arguments of the called method. In some aspects, API access may be governed by an API gateway associated with a corresponding API. In some aspects, incoming API method calls may be routed to an API gateway and the API gateway may forward the method calls to internal services/modules/engines that publish the API and its associated methods.

A service/module/engine that publishes an API may execute a called API method, perform processing on any data received as parameters of the called method, and send a return communication to the method caller (e.g., via an API gateway). A return communication may also include data based on the called method, the method's data parameters and any performed processing associated with the called method.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

The various processing steps, logical steps, and/or data flows depicted in the figures and described in greater detail herein may be accomplished using some or all of the system components also described herein. In some implementations, the described logical steps or flows may be performed in different sequences and various steps may be omitted. Additional steps may be performed along with some, or all of the steps shown in the depicted logical flow diagrams. Some steps may be performed simultaneously. Some steps may be performed using different system components. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing device,” a “computing device,” a “computer,” an “electronic device,” a “mobile device,” a “client device,” a “server,” etc. As used herein, these terms (unless otherwise specified) are to be understood to include at least one processor that uses at least one memory. The at least one memory may store a set of instructions. The instructions may be either permanently or temporarily stored in the memory or memories of the processing device. The processor executes the instructions that are stored in the memory or memories in order to process data. A set of instructions may include various instructions that perform a particular step, steps, task, or tasks, such as those steps/tasks described above, including any logical steps or logical flows described above. Such a set of instructions for performing a particular task may be characterized herein as an application, computer application, program, software program, service, or simply as “software.” In one aspect, a processing device may be or include a specialized processor. As used herein (unless otherwise indicated), the terms “module,” and “engine” refer to a computer application that executes on hardware such as a server, a client device, etc. A module or engine may be a service.

As noted above, the processing device executes the instructions that are stored in the memory or memories to process data. This processing of data may be in response to commands by a user or users of the processing device, in response to previous processing, in response to a request by another processing device and/or any other input, for example. The processing device used to implement the invention may utilize a suitable operating system, and instructions may come directly or indirectly from the operating system.

The processing device used to implement the invention may be a general-purpose computer. However, the processing device described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing device be physically located in the same geographical place. That is, each of the processors and the memories used by the processing device may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing device what to do with the data being processed.

Further, it is appreciated that the instructions or set of instructions used in the implementation and operation of the invention may be in a suitable form such that the processing device may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing device, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing device, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing device that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing device or machines that are used to implement the invention. As used herein, a user interface includes any hardware, software, or combination of hardware and software used by the processing device that allows a user to interact with the processing device. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing device as it processes a set of instructions and/or provides the processing device with information. Accordingly, the user interface is any device that provides communication between a user and a processing device. The information provided by the user to the processing device through the user interface may be in the form of a command, a selection of data, or some other input, for example.

As discussed above, a user interface is utilized by the processing device that performs a set of instructions such that the processing device processes data for a user. The user interface is typically used by the processing device for interacting with a user either to convey information or receive information from the user. However, it should be appreciated that in accordance with some aspects of the system and method of the invention, it is not necessary that a human user actually interact with a user interface used by the processing device of the invention. Rather, it is also contemplated that the user interface of the invention might interact, i.e., convey and receive information, with another processing device, rather than a human user. Accordingly, the other processing device might be characterized as a user. Further, it is contemplated that a user interface utilized in the system and method of the invention may interact partially with another processing device or processing devices, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

What is claimed is:

1. A method comprising:
training, at a first node of a peer-to-peer distributed network, a first version of a machine learning model on a first private data set;
sending, by the first node, the first version of the machine learning model to an aggregation server provided in the peer-to-peer distributed network;
replicating, by the first node, the first version of the first version of the machine learning model on a second node of the peer-to-peer distributed network;
training, by the second node, the machine learning model on a second private data set, resulting in a second version of the machine learning model;
sending, by the second node, the second version of the machine learning model to the aggregation server;
aggregating, by the aggregation server, the first version of the machine learning model and the second version of the machine learning model resulting in an aggregated machine learning model; and
sending, by the aggregation server, the aggregated machine learning model to the first node.

2. The method of claim 1, wherein the first version is a genesis version of the machine learning model.

3. The method of claim 1, further comprising:
replicating, by the first node or the second node, the first version of the machine learning model or the second version of the machine learning model on a third node in the peer-to-peer distributed network;
training, by the third node, the first version of the machine learning model or the second version of the machine learning model using a third private data set, resulting in a third version of the machine learning model; and
sending, by the third node, the third version of the machine learning model to the aggregation server.

4. The method of claim 3, wherein the aggregated machine learning model comprises an aggregation of the first version of the machine learning model, the second version of the machine learning model, and the third version of the machine learning model, and the aggregation server further replicates the aggregated machine learning model on the third node.

5. The method of claim 1, wherein the first node sends weights for the first version of the machine learning model to the aggregation server.

6. The method of claim 1, wherein the second node sends weights for the second version of the machine learning model to the aggregation server.

7. The method of claim 1, wherein the aggregation server sends weights for the aggregated machine learning model to the first node and the second node.

8. The method of claim 1, wherein the peer-to-peer distributed network is a permissioned blockchain network.

9. The method of claim 1, further comprising:
incorporating, by the first node, the aggregated machine learning model into the first version of the machine learning model;
training, by the first node, the first version of the machine learning model with an additional first private dataset, resulting in an updated first version of the aggregated machine learning model;
sending, by the first node, the updated first version of the aggregated machine learning model to the aggregation server;
incorporating, by the second node, the aggregated machine learning model into the second version of the machine learning model;
training, by the second node, the aggregated machine learning model with an additional second private dataset, resulting in an updated second version of the aggregated machine learning model;
sending, by the second node, the updated second version of the aggregated machine learning model to the aggregation server;
aggregating, by the aggregation server, the updated first version of the aggregated machine learning model and the updated second version of the aggregated machine learning model, resulting in a second aggregated machine learning model; and
sending, by the aggregation server, the second aggregated machine learning model to the first node and the second node.

10. The method of claim 1, wherein the first node trains the first version of the machine learning model until a desired accuracy is reached.

11. The method of claim 10, further comprising:
incorporating, by the first node, the aggregated machine learning model into the first version of the machine learning model; and
deploying, by the first node, the first version of the machine learning model for inference generation to a production environment for an implementing organization, wherein the implementing organization is a participant of the peer-to-peer distributed network.

12. A system, comprising:
a peer-to-peer distributed network comprising:
a first node;
a second node; and
an aggregation server;
wherein:
the first node is configured to train a first version of a machine learning model on a first private data set;
the first node is configured to send the first version of the machine learning model to the aggregation server;
the first node is configured to replicate the first version of the first version of the machine learning model on the second node;
the second node is configured to train the machine learning model on a second private data set, resulting in a second version of the machine learning model;
the second node is configured to send the second version of the machine learning model to the aggregation server;
the aggregation server is configured to aggregate the first version of the machine learning model and the second version of the machine learning model resulting in an aggregated machine learning model; and
the aggregation server is configured to send the aggregated machine learning model to the first node.

13. The system of claim 12, wherein the first version is a genesis version of the machine learning model.

14. The system of claim 12, wherein the peer-to-peer distributed network further comprises a third node, and the first node is configured to replicate the first version of the machine learning model on the third node, or the second node is configured to replicate the second version of the machine learning model on the third node;
the third node is configured to train the first version of the machine learning model or the second version of the machine learning model using a third private data set, resulting in a third version of the machine learning model; and
the third node is configured to send the third version of the machine learning model to the aggregation server.

15. The system of claim 14, wherein the aggregated machine learning model comprises an aggregation of the first version of the machine learning model, the second version of the machine learning model, and the third version of the machine learning model, and the aggregation server is configured to send the aggregated machine learning model to the third node.

16. The system of claim 12, wherein the first node is configured to send weights for the first version of the machine learning model to the aggregation server, the second node is configured to send weights for the second version of the machine learning model to the aggregation server, add the aggregation server is configured to send weights for the aggregated machine learning model to the first node and the second node.

17. The system of claim 12, wherein the peer-to-peer distributed network is a permissioned blockchain network.

18. The system of claim 12, wherein:
the first node is configured to incorporate the aggregated machine learning model into the first version of the machine learning model;
the first node is configured to train the first version of the machine learning model with an additional first private dataset, resulting in an updated first version of the aggregated machine learning model;
the first node is configured to send the updated first version of the aggregated machine learning model to the aggregation server;
the second node is configured to incorporate the aggregated machine learning model into the second version of the machine learning model;
the second node is configured to train|the aggregated model with an additional second private dataset, resulting in an updated second version of the aggregated machine learning model;
the second node is configured to send the updated second version of the aggregated machine learning model to the aggregation server;
the aggregation server is configured to aggregate the updated first version of the aggregated machine learning model and the updated second version of the aggregated machine learning model, resulting in a second aggregated model; and
the aggregation server is configured to send the second aggregated model to the first node and the second node.

19. The system of claim 12, wherein the first node is configured to train the first version of the machine learning model until a desired accuracy is reached.

20. The system of claim 19, wherein:
the first node is configured to incorporate the aggregated machine learning model into the first version of the machine learning model; and
the first node is configured to deploy the first version of the machine learning model for inference generation to a production environment for an implementing organization, wherein the implementing organization is a participant of the peer-to-peer distributed network.
